(19) United States
(12) Patent Application Publication
(10) Pub. No.: US 2012/0137062 A1
(43) Pub. Date: May 31, 2012

(54) LEVERAGING COALESCED MEMORY

(75) Inventors: Christopher J. Arges, Austin, TX (US); Nathan D. Fontenot, Georgetown, TX (US); Joel H. Schopp, Austin, TX (US); Michael T. Strosaker, Ausitn, TX (US)

(73) Assignee: International Business Machines Corporation, Armonk, NY (US)

(21) Appl. No.: 12/956,916

(22) Filed: Nov. 30, 2010

(51) Int. Cl. G06F 12/00; G06F 12/08; G06F 9/455

(52) U.S. Cl. 711/113; 718/1; 711/E12.001; 711/E12.019

(57) ABSTRACT

Embodiments of the invention relate to efficiently processing read transactions in a shared file system having multiple virtual machines. Each virtual machine in the file system has access to disk storage and local disk cache. At the same time, each virtual machine in the file system has access to remote disk cache of a remote virtual machine. For each read transaction, the local and/or remote disk cache employed for data blocks to support the transaction. Disk storage is employed to support the transaction in the event that the data blocks are not available in the local and/or remote disk cache.

### BACKGROUND

This invention relates to data storage cache in a computer system environment. More specifically, the invention relates to leveraging access to data storage cache to virtual machines operating in a shared file system.

There are two general categories of data storage, persistent and volatile. Persistent storage uses non-volatile magnetic media for long term and permanent storage of data. There are many types of persistent storage; magnetic disks and flash memory and the most common forms today. These may be attached directly or via other means such as storage area networks (SANs) or Network Attached Storage (NAS). Non-persistent storage uses volatile magnetic media for short term and non-permanent storage of data. Cache is an example of non-persistent data storage. Cache is a high speed storage mechanism commonly employed to store recently used data in a location where it can be efficiently accessed. Disk cache is a form of cache that stores information recently read from data storage; disk cache is stored in random access memory (RAM) or system memory. Processor cache is a form of cache that stores small amounts of information in close proximity to the processor. Use of processor cache invites efficiency into processing of communication instructions.

A virtual machine is a self contained operating environment that behaves as if it is a separate computer, while allowing the sharing of underlying physical machine resources between multiple virtual machines. Each virtual machine operates as a whole machine, while a host of the virtual machine(s) manages resources to support each virtual machine. For example, a virtual machine consists of CPUs, memory, and I/O slots that are a subset of the pool of available resources within a computer system. Each of the virtual machines within the computer system is capable of running a version of an operating system or a specific set of application workloads. Multiple virtual machines in communication with each other may have access to common disk storage. Each of the virtual machines has an individual disk cache. The disk caches of virtual machines with shared disk storage can be coalesced after required data blocks are read from the shared disk.

### BRIEF SUMMARY

This invention comprises a method, system, and article for efficiently accessing data storage blocks in a file system to support a read transaction, and for leveraging use of data storage cache of different virtual machines in the file system to support the efficiency.

In one aspect of the invention, a method is provided for efficiently managing read transactions in a shared file system. More specifically, a shared file system is provided with multiple virtual machines, and with each of the virtual machine having access to both data storage and local data storage cache. A first virtual machine of the file system executes a read from data storage to support a first read transaction. The disk blocks accessed by the first read transaction are temporarily stored in cache of the first virtual machine. Before an independent read transaction is executed by a second virtual machine, the second virtual machine queries other virtual machines in the file system to determine if disk blocks to support the independent read transaction are present in virtual machine cache of other virtual machines in the file system.

In another aspect of the invention, a computer system is provided with a shared file system having multiple virtual machines. Each of the virtual machine has access to both data storage and local data storage cache. A first virtual machine of the file system executes a read from data storage to support a first read transaction. A storage manager temporarily stores disk blocks accessed by the first read transaction in cache of the first virtual machine. Before a second virtual machine executes an independent read transaction, a cache manager local to the second virtual machine queries other virtual machines in the file system, including the first virtual machine, for presence of disk blocks in respective virtual machine cache of the file system virtual machines, to support the independent read transaction.

In yet another aspect of the invention, a computer program product is provided with a computer readable storage medium having embodied computer readable program code. More specifically, computer readable program code is provided local to a first virtual machine of a shared file system to execute a read from data storage to support a first read transaction. The shared file system has multiple virtual machines, with each virtual machine having access to data storage and local data storage cache. Computer readable program code local to the first virtual machine temporarily stores disk blocks accessed by the first read transaction in cache of the first virtual machine. Prior to a second virtual machine executing an independent read transaction, computer readable program code local to the second virtual machine queries other virtual machines in the file system, including the first virtual machine, for presence of disk blocks in respective virtual machine cache of the file system virtual machines, to support the independent read transaction.

Other features and advantages of this invention will become apparent from the following detailed description of the presently preferred embodiment of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a block diagram showing communications between virtual machines and a common storage associated with a read transaction.

FIG. 2 is a block diagram showing communications between virtual machines and a common disk storage associated with a read transaction.

FIG. 3 is a flow chart illustrating a process of performing a read transaction by a virtual machine.

FIG. 4 is a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units described in this specification have been labeled as managers. A manager may be implemented in programmable hardware devices such as field programmable gate arrays, programmable array logic, programmable logic devices, or the like. The manager may also be implemented in software for processing by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the manager and achieve the stated purpose of the manager.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of a write stream manager, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

Memory coalescing is a technique based upon identifying duplicate memory ranges and redirecting the references to the duplicate memory ranges to a single shared copy. The shared instance reduces the aggregate memory footprint and allows a system to run at optimal levels while utilizing a reduced amount of total memory.

A file system is an organization of data and metadata on a storage device; a shared architecture, hereinafter referred to as a shared file system, separates a user interface layer from the file system implementation from drivers that manipulate the storage devices. A shared disk file system provides direct disk access from multiple virtual machines. There are different architectural approaches to a shared disk file system. A virtual shared file system is a collection of individual software layers composed together to provide the traditional file system view. Individual layers are maintained in a central repository and shared across all shared file systems that use them. Layer changes and upgrades only need to be done once in the repository and are then automatically propagated to all virtual file systems.

A system comprising multiple virtual machines operating in a shared file system is provided. The virtual machines are in communication with shared disk storage. Each of the virtual machines can access the shared storage or look for data blocks in caches of other virtual machines. After at least two virtual machines have accessed the shared storage, their caches can be coalesced. When a virtual machine needs to execute a read transaction, the shared file system queries other virtual machines on read transactions prior to accessing the shared disk, i.e. persistent memory, to determine if the data blocks to support the transaction are present in cache of one of the virtual machines in the file system. In one embodiment, the query of virtual machine cache relies on a hash table or a look aside buffer of previously coalesced pages before directing the read transaction to persistent storage. Accordingly, as demonstrated below by block diagrams and the flow chart is a process and system to unconditionally submit a read transaction to volatile storage in the shared file system in an effort to mitigate the quantity of read transactions submitted to disk storage.

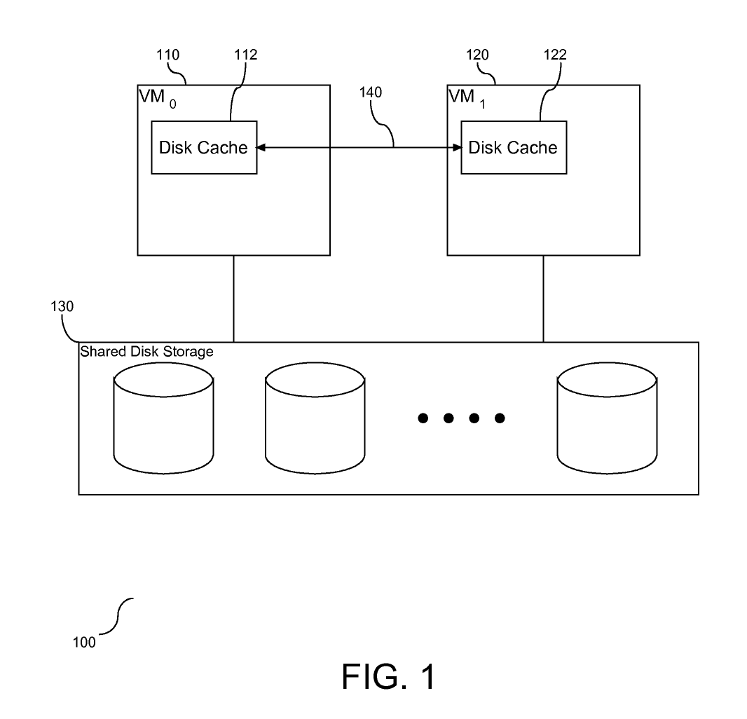

FIG. 1 is a block diagram (100) showing communications between virtual machines and shared disk storage. Virtual machines (110) and (120) are in communication with shared disk storage (130). It should be noted, that the number of the virtual machines is not limited by the two machines shown herein. In one embodiment, the quantity of virtual machines can be expanded to include a greater quantity of virtual machines. Virtual machines (110) and (120) have individual disk caches (112) and (122), respectively. Each of the virtual machines (110) and (120) can access disk caches associated with other virtual machines. More specifically, virtual machine (110) can communicate with virtual machine (120), and through this communication virtual machine (110) has access to cache (122) and virtual machine (120) has access to cache (112).

As illustrated in FIG. 1, to support a read transaction, virtual machine (110) may communication with local disk cache (112), remote disk cache (122) as represented by arrow (140), or disk storage (130). The most efficient manner of processing the read transaction is through disk blocks present in local cache (112). However, if the data blocks to support the transaction are not present in local data cache, another efficient and supported transaction is a remote data cache access. Accessing disk storage to support the read transaction is available, but from a time perspective is the most expensive. Each of the virtual machines (110) and (120) can access remote disk cache. More specifically, virtual machine (110) can communicate with virtual machine (120), and through this communication virtual machine (110) has access to disk cache (122) and virtual machine (120) has access to disk cache (112).

In the event that the data blocks to support the read transaction are only present in remote data cache, the data blocks may be copied to local data cache or a pointer to the remote data may be updated. In one embodiment, when memory of the virtual machines is coalesced, there is no need for copying data blocks from memory associated with one virtual machine to memory associated with another virtual machine since a requesting virtual machine can point to the same data block in memory. Accordingly, the inter- partition copy from local cache (112) to remote cache (122) or local cache (122) to remote cache (112) may be in the form of a memory to memory copy.

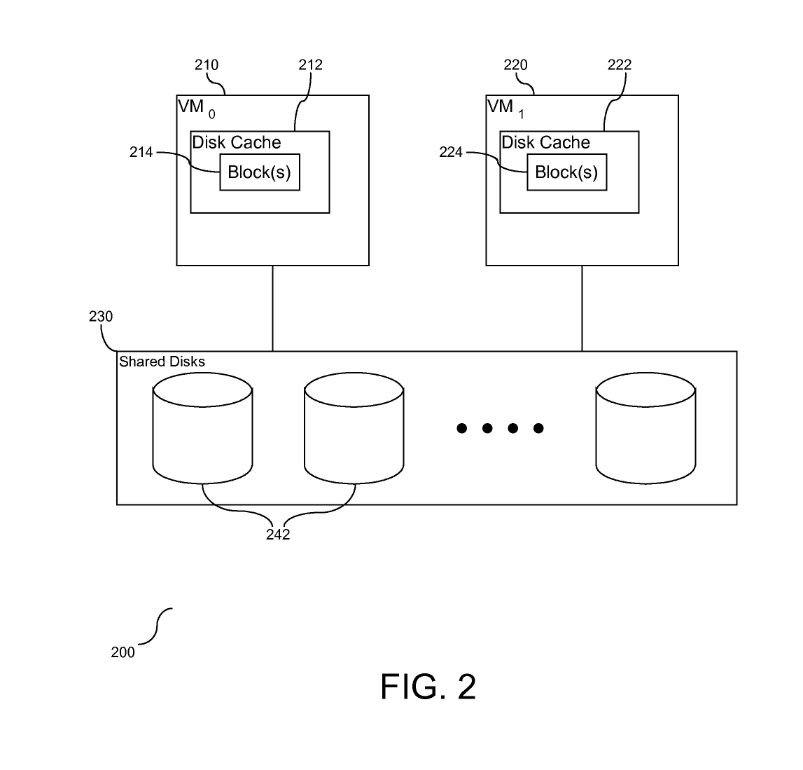

FIG. 2 is a block diagram (200) showing communications between virtual machines and shared disk storage, and the communication of data blocks to support one or more read transactions. Virtual machines (210) and (220) are in communication with shared disk storage (230). It should be noted, that the number of the virtual machines is not limited by the two machines shown herein. In one embodiment, the quantity of virtual machines can be expanded to include a greater quantity of virtual machines. Virtual machines (210) and (220) have individual disk caches (212) and (222), respectively. As shown, each of the disk caches (212) and (222) are populated with data blocks from prior read transactions. More specifically, disk cache (212) is populated with data blocks (214) and disk cache (222) is populated with data blocks (224) from one or more recent data transactions. In addition, data blocks (244) are present in one or more disks (242) of disk storage (230). The data blocks (214) and (224) in disk cache (212) and (222) of the virtual machines (210) and (220), respectively, may be employed to support one or more read transactions and mitigate access to disk storage (230). In the event that the data blocks (214) and (224) in disk cache cannot support a read transaction, the virtual machine processing the read transaction is directed to disk storage (230) for data blocks (214) and (244) to support the read transaction. Accordingly, three separate data storage elements are employed to support processing of a read transaction, including local disk cache, remote disk cache, and disk storage.

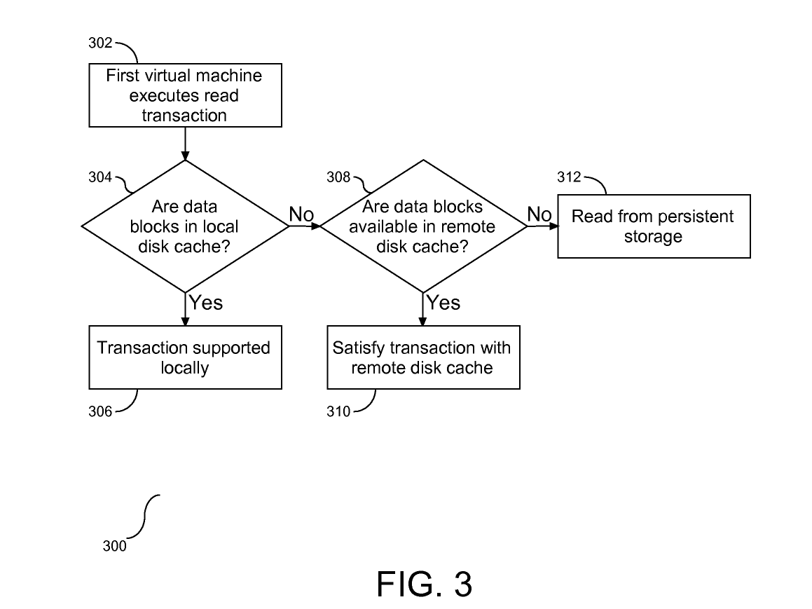

FIGS. 1 and 2 are block diagrams illustrating the physical relationship of the virtual machines and disk cache access among the machines. FIG. 3 is a flow chart (300) illustrating a read transaction by a virtual machine. To mitigate accessing data storage, each read transaction initiates an unconditional query to disk cache. In the example shown herein, a first virtual machine executes a read transaction (302) and in the process of executing the read transaction sends a query to determine if data blocks to support the transaction are available in local disk cache (304). If it is determined that the data blocks are in local disk cache, then the transaction is supported locally without a remote transaction (306). Conversely, if it is determined that the data blocks are not available in local disk cache, then a query is transmitted to each of the virtual machines in communication with a requesting virtual machine to determine if data blocks to support the transaction are available in remote disk cache (308). As described above with respect to FIGS. 1 and 2, each virtual machine has local disk cache configured to support remote access from a remote virtual machine. Access to remote disk cache is more efficient than a direct memory access to persistent storage. Accordingly, prior to performing a direct memory access to persistent storage, the virtual machine seeks availability of the data block in local and/or remote disk cache.

A positive response to the determination at step (308) is an indication that a direct memory access will not be required to complete the read transaction. More specifically, the positive response to the determination at step (308) is following by satisfying the transaction from remote disk cache (310). The transaction at step (310) is processed by either copying the subject data blocks from the remote disk cache to the local disk cache or updating a pointer to the remote disk cache with the identified data blocks. In a non- shared memory system, the requested disk blocks are copied from the remote disk cache to the local disk cache. Conversely in a shared memory system that supports a shared memory pointer, the shared memory pointer is updated to the identified remote disk cache. If however, the response to the determination at step (308) is negative a direct memory access (312) is executed by the virtual machine supporting the read transaction to read data blocks from disk storage to support the read transaction.

As demonstrated in FIG. 3, disk cache is leveraged in a manner to mitigate transactions to disk storage. Each processed read transaction retains a temporary copy of the supporting data blocks in disk cache. The functionality disclosed herein enables virtual machines to perform inter-virtual machine communications to access remote disk cache of other virtual machines to support a read transaction with data blocks temporarily stored in disk cache. Accordingly, disk cache in the shared file system is leveraged to mitigate disk access for a read transaction.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to a flowchart illustration and/or block diagrams of methods, apparatus (systems) and computer program products according to embodiments of the invention. It will be understood that each block of the flowchart illustration and/or block diagrams, and combinations of blocks in the flowchart illustration and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

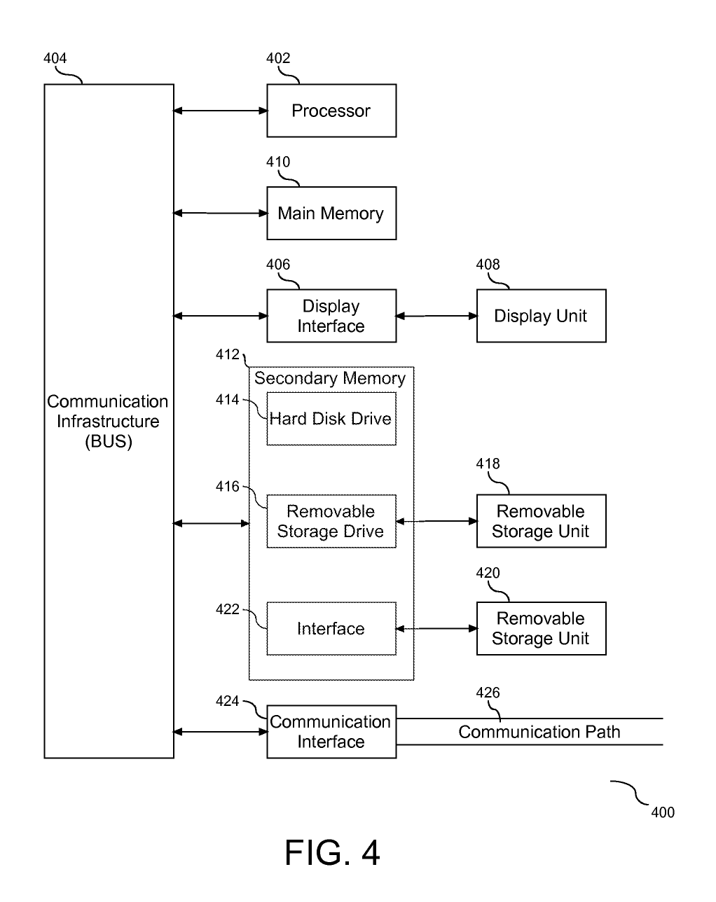

Referring now to FIG. 4 is a block diagram (400) showing a system for implementing an embodiment of the present invention. The computer system includes one or more processors, such as a processor (402). The processor (402) is connected to a communication infrastructure (404) (e.g., a communications bus, cross-over bar, or network). The computer system also includes a main memory (410), preferably random access memory (RAM), and may also include a secondary memory (412). The secondary memory (412) may include, for example, a hard disk drive (414) and/or a removable storage drive (416), representing, for example, a floppy disk drive, a magnetic tape drive, or an optical disk drive. The removable storage drive (416) reads from and/or writes to a removable storage unit (418) in a manner well known to those having ordinary skill in the art. Removable storage unit (418) represents, for example, a floppy disk, a compact disc, a magnetic tape, or an optical disk, etc., which is read by and written to by removable storage drive (416). As will be appreciated, the removable storage unit (418) includes a computer readable medium having stored therein computer software and/or data.

In alternative embodiments, the secondary memory (412) may include other similar means for allowing computer programs or other instructions to be loaded into the computer system. Such means may include, for example, a removable storage unit (420) and an interface (422). Examples of such means may include a program package and package interface (such as that found in video game devices), a removable memory chip (such as an EPROM, or PROM) and associated socket, and other removable storage units (420) and interfaces (422) which allow software and data to be transferred from the removable storage unit (420) to the computer system.

The computer system may also include a communications interface (424). Communications interface (424) allows software and data to be transferred between the computer system and external devices. Examples of communications interface (424) may include a modem, a network interface (such as an Ethernet card), a communications port, or a PCMCIA slot and card, etc. Software and data transferred via communications interface (424) are in the form of signals which may be, for example, electronic, electromagnetic, optical, or other signals capable of being received by communications interface (424). These signals are provided to communications interface (424) via a communications path (i.e., channel) (426). This communications path (426) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (410) and secondary memory (412), removable storage drive (416), and a hard disk installed in hard disk drive (414).

Computer programs (also called computer control logic) are stored in main memory (410) and/or secondary memory (412). Computer programs may also be received via a communication interface (424). Such computer programs, when run, enable the computer system to perform the features of the present invention as discussed herein. In particular, the computer programs, when run, enable the processor (402) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be appreciated that, although specific embodiments of the invention have been described herein for purposes of illustration, various modifications may be made without departing from the spirit and scope of the invention. In particular, in one embodiment, a virtual machine manager, also known as a hypervisor, manages memory. The hypervisor may be employed to update a pointer to disk cache when the data to support the read transaction is available in disk cache of another virtual machine. The requesting virtual machine is referred to as a guest. To ensure that the disk cache of the host machine contains the appropriate disk block(s) to support the read transaction, the host machine may ensure that the disk block(s) are only available to the guest machine as a read only. Accordingly, the scope of protection of this invention is limited only by the following claims and their equivalents.

We claim:

1. A method comprising:
a shared file system having multiple virtual machines, each virtual machine having access to data storage and local data storage cache;
a first virtual machine of the file system executing a read from data storage to support a first read transaction;
temporarily storing disk blocks accessed by the first read transaction in cache of the first virtual machine; and
prior to a second virtual machine executing an independent read transaction, the second virtual machine querying other virtual machines in the file system, including the first virtual machine, for presence of disk blocks in respective virtual machine cache of the file system virtual machines, to support the independent read transaction.

2. The method of claim 1, further comprising the second virtual machine performing an inter-virtual machine communication with the first virtual machine cache to support the independent read transaction in response to presence of disk blocks in the first virtual machine cache to support the independent read transaction.

3. The method of claim 2, further comprising the second virtual machine copying the disk blocks from the first virtual machine cache to the second virtual machine cache.

4. The method of claim 2, further comprising a virtual machine manager updating a pointer to the first virtual machine cache to support the independent read transaction.

5. The method of claim 1, further comprising the second virtual machine reading data from data storage to support the independent read transaction.

6. A system comprising:
a shared file system having multiple virtual machines, each virtual machine having access to data storage and local data storage cache;
a first virtual machine of the file system to execute a read from data storage to support a first read transaction;
a storage manager to temporarily store disk blocks accessed by the first read transaction in cache of the first virtual machine; and
prior to a second virtual machine executing an independent read transaction, a cache manager local to the second virtual machine to query other virtual machines in the file system, including the first virtual machine, for presence of disk blocks in respective virtual machine cache of the file system virtual machines, to support the independent read transaction.

7. The system of claim 6, further comprising the cache manager local to the second virtual machine to perform an inter-virtual machine communication with the first virtual machine cache to support the independent read transaction in response to presence of disk blocks in the first virtual machine cache to support the independent read transaction.

8. The system of claim 7, further comprising the cache manager local to the second virtual machine to copy the disk blocks from the first virtual machine cache to the second virtual machine cache.

9. The system of claim 7, further comprising a virtual machine manager to update a pointer to the first virtual machine cache to support the independent read transaction.

10. The system of claim 6, further comprising a read manager in communication with the cache manager, the read manager to read data from data storage to support the independent read transaction.

11. A computer program product, the computer program product comprising a computer readable storage medium having computer readable program code embodied therewith, the computer readable program code comprising:
computer readable program code local to a first virtual machine of a shared file system having multiple virtual machines, with each virtual machine having access to data storage and local data storage cache, the program code to execute a read from data storage to support a first read transaction;
computer readable program code local to the first virtual machine to temporarily store disk blocks accessed by the first read transaction in cache of the first virtual machine; and
prior to a second virtual machine executing an independent read transaction, computer readable program code local to the second virtual machine to query other virtual machines in the file system, including the first virtual machine, for presence of disk blocks in respective virtual machine cache of the file system virtual machines, to support the independent read transaction.

12. The computer program product of claim 11, further comprising computer readable program code local to the second virtual machine to perform an inter-virtual machine communication with the first virtual machine cache to support the independent read transaction in response to presence of disk blocks in the first virtual machine cache to support the independent read transaction.

13. The computer program product of claim 12, further comprising computer readable program code local to the second virtual machine to copy the disk blocks from the first virtual machine cache to the second virtual machine cache.

14. The computer program product of claim 12, further comprising computer readable program code to update a pointer to the first virtual machine cache to support the independent read transaction.

15. The computer program product of claim 12, further comprising computer readable program code local to the second virtual machine to read data from data storage to support the independent read transaction.
